(19) United States
(12) Patent Application Publication
(10) Pub. No.: US 2020/0218092 A1
(43) Pub. Date: Jul. 9, 2020

(54) METHOD OF DYNAMIC ELECTRONIC STORAGE OF CORRECTIVE LENS MANUFACTURING CRITERIA ON EYEGLASS FRAMES AND EYEGLASS FRAMES FORMED THEREBY

(71) Applicants: Edward L. McCall, Sewickley, PA (US); John Traina, Pittsburgh, PA (US)

(72) Inventors: Edward L. McCall, Sewickley, PA (US); John Traina, Pittsburgh, PA (US)

(21) Appl. No.: 16/738,312

(22) Filed: Jan. 9, 2020

Related U.S. Application Data
(60) Provisional application No. 62/790,226, filed on Jan. 9, 2019.

(51) Int. Cl. G02C 11/00; H04B 5/00; G06K 7/14; G02C 5/00

(52) U.S. Cl. CPC G02C 11/10; H04B 5/0062; H04B 5/0031; G02C 5/00; G06K 7/1404

(57) ABSTRACT

A method of dynamic electronic storage of corrective lens manufacturing criteria comprises the steps of: a) providing eyeglass frame for holding a pair of corrective lenses; b) coupling a rewritable electronic storage medium to the eyeglass frame; c) storing corrective lens manufacturing criteria on the rewritable electronic storage medium. The corrective lens manufacturing criteria includes a distance power reference location, a near power reference location and a prism reference point location, astigmatism criteria, magnitudes and angles for prism, distance and near field vision correction of single vision or progressive lenses, lens design type and lens design vender. The rewritable electronic storage medium may be an RFID device embedded within a temple part of the frame, or a QR Code, such as a micro QR code, which is linked to a webpage containing the corrective lens manufacturing criteria.

### RELATED APPLICATIONS

The present application claims the benefit of U.S. Provisional Patent Application Ser. No. 62/790,226, filed Jan. 9, 2019 titled “Method of Dynamic Electronic Storage of Corrective Lens Manufacturing Criteria on Eyeglass Frames and Eyeglass Frames Formed Thereby” which application is incorporated herein by reference.

### BACKGROUND OF THE INVENTION

### 1. Field of the Invention

The present invention relates to corrective lens manufacturing, more particularly to a method of dynamic electronic storage of corrective lens manufacturing criteria on eyeglass frames and eyeglass frames formed thereby.

### 2. Background Information

The use of corrective lenses containing multiple optical powers to treat presbyopia, the typically age-related loss of adaptive focusing ability in the human eye, has been in wide use since the late 18^{th} century. Early approaches to the problem were later refined into the bifocal and trifocal lenses seen today.

In the 20^{th} century multifocal lenses with a gradual transition to the addition power were commercialized. Known as Progressive Addition Lenses (PAL's) or progressive lenses, they offered the patient better optical properties than bifocal or trifocal lenses, given their ability to gradually transition to the add power; and improved cosmetics since they eliminated the visible line or circle at what is known as the power boundary.

As PAL's became popular, conventional lens fabrication techniques were adapted to fabricate the patient's prescription with these new features. In conventional ophthalmic lens surface generation for a patient that does not suffer from presbyopia, known as single vision manufacturing in the industry, a spherically symmetrical lens blank with known front surface radius is attached to a metal block with a low melting point material, in a process called blocking. Due to the spherical symmetry of the lens the blank location on the block is not restricted in rotation. After blocking, the back surface of the lens is machined to create the necessary curvatures in two perpendicular meridians (referred to as sphere and cylinder). Utilizing different radii in the two perpendicular meridians, the patient's vision can be corrected for astigmatism. There is no add power correction for presbyopia in this type of lens.

In conventional manufacturing of a progressive lens the back surface generation process is the same as that used for single vision but an add power is molded into a specific area of the front surface of the blank to correct the patient's presbyopia. Since the location of the add power portion relative to the patient's pupil is important, the blocking process for a front surface progressive is more complex because the blank must be located precisely relative to the patient's pupil. To facilitate this location process for lens fabricators, progressive lens blank manufacturers engraved circles in and affixed tape markings on the front surface of the blank.

In the early 21^{st} century, progressive lens manufacturing changed with the advent of digital lens designs. With digital lens designing technology, the add power along with the patient's sphere and cylinder prescription is now conventionally machined into the back surface of a lens blank with a spherical front like that used for the single vision process.

Some advantages of this approach are: 1) single vision lens blanks can be used and they are simpler to block than front surface progressives; 2) add power profiles can be better customized for the patient; 3) the fabricator's inventory of blanks can be smaller and less expensive because there is no need to stock different add powers as is the case with front surface progressive lenses; and 4) front surface progressive blanks are more expensive than simple spherical front surface blanks. Further having select manufacturing criteria on the lens itself allows the patient to easily have replacement lenses formed as needed.

Since single vision blanks are used for digital lens manufacturing and they do not have location marks, standards have been developed to engrave semi-visible marks in the back surfaces of digital lenses that are analogous to those of front surface progressive lenses. Note that it is possible and indeed commonly done in practice to engrave visible marks in the periphery of digital lenses, outside of the usable area, so that fabricators can properly locate a lens in a frame without using the engraved circles and markings.

The practice of engraving semi-visible marks in the back surface of digital lenses can have several issues: 1) suitable engraving equipment is expensive from a capital expenditure standpoint, generally requiring precision positioning equipment and excimer lasers; 2) near sighted patients that have prescriptions with high negative powers sometimes report they are able to see the marks and thus find them distracting; 3) engraving can cause complications during the various coating processes typically used for ophthalmic lenses, resulting in rework or scrap. As a result of these difficulties limited information is provided.

There remains a need for an efficient effective method of storing corrective lens manufacturing criteria.

### SUMMARY OF THE INVENTION

One aspect of the present invention provides a method of dynamic electronic storage of corrective lens manufacturing criteria which comprises the steps of: a) providing eyeglass frame for holding a pair of corrective lenses; b) coupling a rewritable electronic storage medium to the eyeglass frame ;c) storing corrective lens manufacturing criteria on the rewritable electronic storage medium. The corrective lens manufacturing criteria includes a distance power reference location, a near power reference location and a prism reference point location, astigmatism criteria, magnitudes and angles for prism, distance and near field vision correction of single vision or progressive lenses, lens design type and lens design vender. The rewritable electronic storage medium may be an RFID device embedded within a temple part of the frame, or a QR Code, including a micro QR code, which is linked to a webpage containing the corrective lens manufacturing criteria.

The present invention provides eyeglass frames formed by the process of the invention, wherein the eyeglass frame becomes integrated with the specific corrective lenses associated therewith.

These and other advantages of the present invention will be described in connection with the preferred embodiments that are disclosed in connection with attached figures wherein like reference numerals represent like elements throughout.

### BRIEF DESCRIPTION OF THE FIGURES

FIG. 1 is a perspective schematic view of eyeglass frames for holding a pair of corrective lenses including a rewritable electronic storage medium coupled to the frame wherein the rewritable electronic storage medium includes corrective lens manufacturing criteria stored thereon in accordance with a first embodiment of the present invention;

FIG. 2 is a front elevation view of an ophthalmologic corrective lens schematically illustrating some lens manufacturing criteria thereon;

FIG. 3 is a schematic view of the eyeglass frames of FIG. 1 together with a system for reading and re-writing the electronic storage medium with corrective lens manufacturing criteria in accordance with a first embodiment of the present invention

FIG. 4 is a view of a QR code which may be used in a second embodiment of the present invention;

FIG. 5 is comparative view of a micro QR code and a QR code, each of which may be used in a second embodiment of the present invention; and

FIG. 6 is a schematic view of modified eyeglass frames of a second embodiment of the present invention together with a system for reading and re-writing electronic storage medium with corrective lens manufacturing criteria in accordance with a second embodiment of the present invention.

### DESCRIPTION OF THE PREFERRED EMBODIMENTS

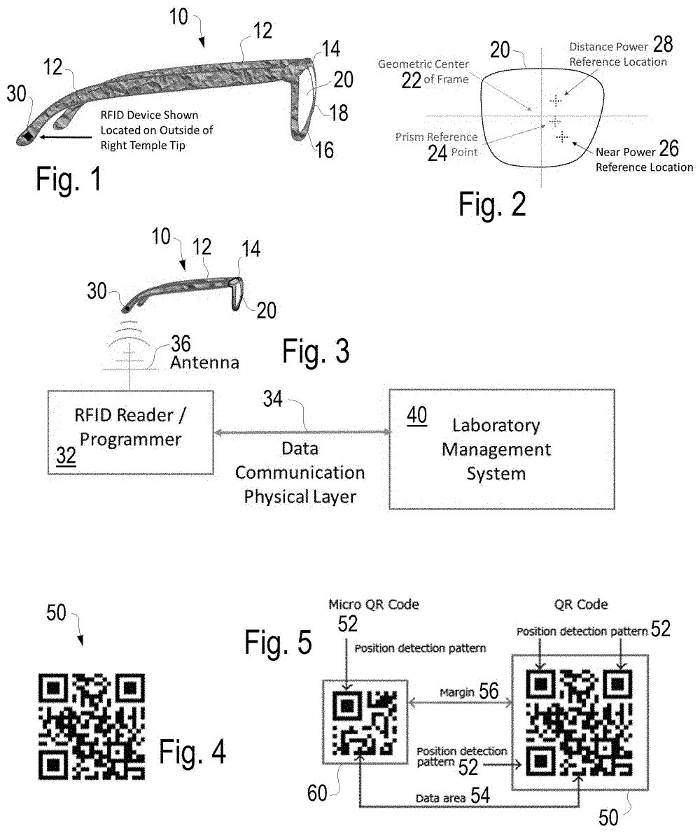

FIG. 1 is a perspective view of eyeglass frames 10 for holding a pair of corrective lenses 20 including a rewritable electronic storage medium 30 formed as an RFID tag coupled to the frame 10 wherein the rewritable electronic storage medium 30 includes corrective lens manufacturing criteria stored thereon associated with the corrective lenses 20 associated with the frame 10.

The eyeglass frame 10 has two basic parts, a frame front 14 and the two temples 12. The frame front 14 will have two areas or openings 16 for receiving the corrective lenses 20 therein coupled by a bridge 18. The eyeglass frame 10 may be made from a number of materials such as plastic, metal, wood and even bone, and combinations thereof. Plastic materials such as cellulose acetate, xylonite, cellulose propionate and nylon are quite common and yield a strong lightweight frame.

In the first embodiment of the present invention the innovation is using a rewritable electronic storage medium 30 formed as a passive RFID device or RFID tag. Passive RFID device means the device requires no internal power source such as a battery. The radio frequency identification (RFID) device is capable of non-volatile storage meaning the data is retained without power applied. As known in the art a passive tag is an RFID tag that does not contain a battery wherein the power is supplied by the reader. When radio waves from the reader are encountered by a passive RFID tag, the coiled antenna within the tag forms a magnetic field. The tag draws power from it, energizing the circuits in the tag. The tag then sends the information encoded in the tag's memory. The medium 30 is programmed to contain all the required information for manufacturing of the corrective lenses 20 associated with the frame.

FIG. 1 shows an RFID device 30 located on the outside of the temple tip of a typical eyeglass frame 10, though many other locations on the frame 10 are possible. Inside surface of the temple 12 or frame front 14 represent less obtrusive locations, but this is merely for illustrative purposes. The device 30 shown is approximately 3 mm by 3 mm by 1 mm, though devices 30 with smaller dimensions can be applicable. If the device 30 is implanted in the body of the frame 10 it could become invisible and even more locations are possible.

The collection of information is referenced herein as the corrective lens manufacturing criteria, some of which will be discussed further below. FIG. 2 shows a typical progressive ophthalmic lens 20. Detailed in the figure are crosshairs defining precisely where an optician would place a power measuring device, such as a lensometer, in order to assess the conformance of an ophthalmic lens 20 with its optical specification. Since a person skilled in the art of making eyeglasses can easily locate the geometric center 22 of a frame opening by direct observation, in this embodiment the frame geometric center 22 has been chosen as a reference to define the locations of the distance power 28, near power 26 and the prism reference point 24. Along with this information, prism magnitudes, angles, lens design vendor and lens type may be stored in RFID device 30. The locations are recorded as horizontal and vertical displacements from geometric center. FIG. 2 shows only some of the corrective lens manufacturing criteria associated with a lens 20 and shown relative to the geometric center 22 of the lens 20, the prism reference point 24, the near power point 26 and the distance power point 28 which can be given as distances relative to the center 22

RFID tags used as medium 30 can store significantly more corrective lens manufacturing criteria than what data has been currently engraved on lenses 20, and it is anticipated that the power locations 26 and 28, astigmatism, magnitudes and angles for prism, distance and near field vision correction of single vision or progressive lenses, as well as other lens properties such as lens design type, lens design vender can also be included. Commercially available RFID tags of approximately 3 mm by 3 mm by 1 mm exhibit sufficient storage and is small enough to affix to an eyeglass frame 10 in an unobtrusive manner and effectively form the medium 30 of the invention. It is preferred that the embodiment will use an RFID device 30 that possesses the ability to read and write to its storage locations multiple times. This allows lenses 20 to be changed in an existing frame 10 multiple times, as an individual's lenses prescription can change over the life of a given frame 10.

Also important is the potential to use the RFID device's internal serial number as a link correlating the lens or lenses 20 and frame 10 to a database of information concerning their assignment to a patient, a doctor and/or a lab.

FIG. 3 shows how an RFID reading and programming device 30 are integrated into the data acquisition and control system of an ophthalmic lab so as to read and write the aforementioned lens data into an RFID device 30 mounted on an eyeglass frame 10. The ophthalmic industry, like many others, has adopted standard information protocols to facilitate communication of data between the various types of machines and metrology found in a modern laboratory. An RFID reading and programming device 32 can be made to communicate via linkage or layer 34 with the physical layers and industry standard protocols typical of the ophthalmic industry and thus can be integrated into these systems 40.

The RFID reading and programming device 32 is also in communication with the device 30 via antenna 36 for reading from and writing to the device. The protocols and details of the RFID reading and programming are well known in the art and will not be detailed in this discussion.

FIG. 4 is a view of a QR code 50 which may be used in a second embodiment of the present invention. QR codes 50 are a matrix barcode and were developed 25 years ago in the automobile industry and have become ubiquitous and reliable. Readers are widely available and may be downloaded onto standard smartphones 70. A QR code 50 includes position protection data 52 and the data 56 with a margin 56. A QR code 50 can be any size but it is effected by the resolution of the associated scanning device, for this application considered a conventional smartphone 70. In this environment sizes of 0.4″ for QR code 50 is possible and still be read by conventional scanners 70.

Some frames 10 may not accommodate QR code 50 of 0.4″. A micro QR code 60 is developed shown in FIG. 5 and can be considered as a subset of QR codes 50. A major feature of Micro QR Code 60 is it has only one position detection pattern 52, compared with regular QR Code 50 that require a certain amount of area because position detection patterns 52 are located at the three corners of a symbol. Furthermore, QR Code 50 requires at least a four-module wide margin 56 around a symbol, whereas a two-module wide margin 56 is enough for Micro QR Code 60. This configuration of Micro QR Code 60 allows printing in areas even smaller than QR Code.

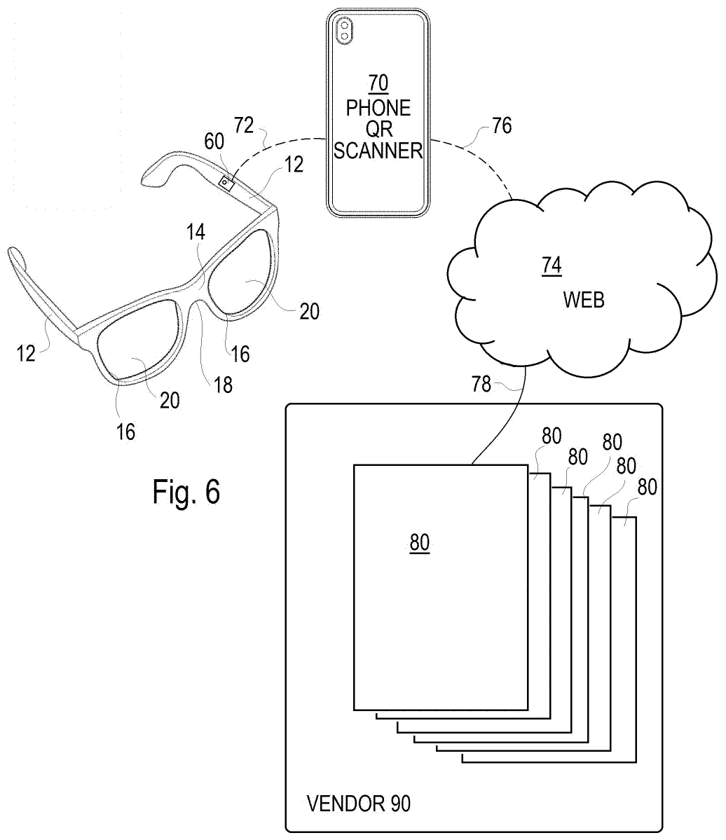

FIG. 6 is a schematic view of modified eyeglass frames 10 of a second embodiment of the present invention together with a system for reading and re-writing electronic storage medium with corrective lens manufacturing criteria in accordance with a second embodiment of the present invention. In this embodiment coupling a rewritable electronic storage medium to the eyeglass frame 10 comprises adding a QR code 50 or Micro QR Code 60 to the frame 10. The QR code 50 or Micro QR Code 60 can be read by a conventional scanner that is easily downloadable onto a conventional smartphone 70. Unlike the RFID device 30 above, the scanning 72 requires a line of site to the QR code 50 or Micro QR Code 60 (and there maybe orientation requirements). With the scanner 70 coupled 76 to the web 74 the QR code 50 or Micro QR Code 60 can direct the scanning device 70 to a reading and re-writing electronic storage medium in the form of a webpage 80 containing the corrective lens manufacturing criteria. A vendor 90 can house a number of unique webpages 80, each one associated with one frame 10 via a QR code 50 or Micro QR Code 60, assuming the vendor is online represented by connection 78. The mechanics of writing to and reading from a webpage are believed to be well known to those in the art. The second embodiment has essentially no practical limit on the amount of data storage available.

### Benefits of the Invention

Currently progressive lens engravings contain limited information: add power, lens design vendor identity and reference circles separated by 34 mm whose midpoint is typically the optical center of the lens.

With the invention described herein several benefits ensue. For example more information can be encoded than is currently practical with engraving, with virtually unlimited data available in the second embodiment of the present invention. Capital expenditure for the optics lab can be greatly reduced since it is believed an RFID reader/programmer can be integrated into a lab's operations for much less money than a suitable lens engraving system, and similarly in the second embodiment QR scanners are almost no cost and the cost of setting up and maintaining webpages 80 for each frame 10 are believed to be far less than the existing capital engraving expense. It should further be understood that there are methods of monetizing the pages 80 for the vendor 90 under SAAS models. The chance of rework and scrap due to engraving issues is eliminated with the present invention. Cycle time for processing a lens will improve considerably since engraving operations typically take up to a minute and it is believed the RFID read/write process and QR scanning web page read/write process can be many times faster. Further, if a finished pair of eyeglasses are separated from their hardcopy manufacturing documentation before they are dispensed to the patient, the invention described herein provides the lab with an easy mechanism to associate their finished goods with the proper patient, namely the RFID device's internal serial number be used to correlate the lens or lenses 20 and frame 10 to a database of information concerning their assignment to a patient, doctor and/or lab, or the unique webpage 80 of the second embodiment may similarly be utilized.

Although the present invention has been described with particularity herein, the scope of the present invention is not limited to the specific embodiment disclosed. It will be apparent to those of ordinary skill in the art that various modifications may be made to the present invention without departing from the spirit and scope thereof. The scope of the invention is not to be limited by the illustrative examples described above.

What is claimed is:

1. A method of dynamic electronic storage of corrective lens manufacturing criteria comprising the steps of:
a) Providing eyeglass frame for holding a pair of corrective lenses;
b) Coupling a rewritable electronic storage medium to the eyeglass frame;
c) Storing corrective lens manufacturing criteria on the rewritable electronic storage medium.

2. The method of dynamic electronic storage of corrective lens manufacturing criteria according to claim 1 wherein the corrective lens manufacturing criteria includes a distance power reference location, a near power reference location and a prism reference point location.

3. The method of dynamic electronic storage of corrective lens manufacturing criteria according to claim 2 wherein the corrective lens manufacturing criteria further includes a plurality of the following: astigmatism criteria, magnitudes and angles for prism, distance and near field vision correction of single vision or progressive lenses, lens design type and lens design vender.

4. The method of dynamic electronic storage of corrective lens manufacturing criteria according to claim 1 wherein the rewritable electronic storage medium comprises an RFID device secured to the frame.

5. The method of dynamic electronic storage of corrective lens manufacturing criteria according to claim 4 wherein the RFID tag is embedded within a temple part of the frame.

6. The method of dynamic electronic storage of corrective lens manufacturing criteria according to claim 1 wherein the rewritable electronic storage medium includes a QR Code secured to the frame.

7. The method of dynamic electronic storage of corrective lens manufacturing criteria according to claim 6 wherein the QR code is linked to a webpage containing the corrective lens manufacturing criteria.

8. The method of dynamic electronic storage of corrective lens manufacturing criteria according to claim 7 wherein the QR code is a micro QR code.

9. An eyeglass frame formed according to the method of claim 1.

10. An eyeglass frame for holding a pair of corrective lenses including a rewritable electronic storage medium coupled to the frame wherein the rewritable electronic storage medium includes corrective lens manufacturing criteria stored thereon.

11. The eyeglass frame according to claim 10 wherein the corrective lens manufacturing criteria includes a distance power reference location, a near power reference location and a prism reference point location.

12. The eyeglass frame according to claim 11 wherein the corrective lens manufacturing criteria further includes a plurality of the following: astigmatism criteria, magnitudes and angles for prism, distance and near field vision correction of single vision or progressive lenses, lens design type and lens design vender.

13. The eyeglass frame according to claim 10 wherein the rewritable electronic storage medium comprises an RFID device secured to the frame.

14. The eyeglass frame according to claim 13 wherein the RFID device is embedded within a temple part of the frame.

15. The eyeglass frame according to claim 14 wherein the corrective lens manufacturing criteria includes a distance power reference location, a near power reference location and a prism reference point location.

16. The eyeglass frame according to claim 15 wherein the corrective lens manufacturing criteria further includes a plurality of the following: astigmatism criteria, magnitudes and angles for prism, distance and near field vision correction of single vision or progressive lenses, lens design type and lens design vender

17. The eyeglass frame according to claim 10 wherein the rewritable electronic storage medium includes a QR Code secured to the frame.

18. The eyeglass frame according to claim 17 wherein the QR code is linked to a webpage containing the corrective lens manufacturing criteria.

19. The eyeglass frame according to claim 18 wherein the corrective lens manufacturing criteria includes a distance power reference location, a near power reference location and a prism reference point location.

20. The eyeglass frame according to claim 18 wherein the QR code is a micro QR code.
